(19) United States
(12) Patent Application Publication
(10) Pub. No.: US 2014/0237486 A1
(43) Pub. Date: Aug. 21, 2014

(54) METHOD AND APPARATUS FOR INTER-WIDGET COMMUNICATION

(71) Applicants: Jinfeng Zhang, Beijing (CN); Canfeng Chen, Beijing (CN); Minjun Xi, Beijing (CN); Yang Deng, Beijing (CN); Feifei Wu, Beijing (CN)

(72) Inventors: Jinfeng Zhang, Beijing (CN); Canfeng Chen, Beijing (CN); Minjun Xi, Beijing (CN); Yang Deng, Beijing (CN); Feifei Wu, Beijing (CN)

(73) Assignee: Nokia Corporation, Espoo (FI)

(21) Appl. No.: 14/349,072

(22) PCT Filed: Sep. 30, 2011
(86) PCT No.: PCT/CN2011/080485

§ 371 Date: Apr. 2, 2014

(51) Int. Cl. G06F 9/54

(52) U.S. Cl. CPC G06F 9/546
USPC 719/315

(57) ABSTRACT

Various methods are provided for facilitating inter-widget communications. One example method may include receiving a message from a first widget of a plurality of widgets for storage in a data file. The method may also include concurrently enabling another message in the data file to be accessed by at least a second widget of the plurality of widgets. The method may further include causing an information file to record a status of the data file to enable concurrent receiving and accessing of messages in the data file.

### TECHNOLOGICAL FIELD

Embodiments of the present invention relate generally to widgets and, more particularly, relate to a method, apparatus, and computer program product for inter-widget communications using file input and/or output operations.

### BACKGROUND

With the rapid advance of web technology, more and more applications are emerging that are operated completely over the Internet. One such application is a widget.

A widget is a stand-alone application that may be executed in a third party widget engine and/or may be executed within another application. Currently, there are several widget engines, these engines include Apple® Dashboard, Microsoft® gadgets, Portlets, Opera browser's rendering engine, Nokia® QT web runtime, etc. Widgets are growing in popularity and as the number of widgets increases, it is possible that they may be combined together (e.g. widget collaboration) to provide rich Internet applications.

### BRIEF SUMMARY

A method, apparatus and computer program product are therefore provided according to an example embodiment to enable inter-widget communications. In some example embodiments described herein, inter-widget communications are accomplished using file input and output operations. A first file, such as a data file, may be used to receive messages from and transfer messages to a plurality of widgets. The data file therefore allows for concurrent reading of the data file by one or more of the plurality of widgets. Further, multiple widgets may write to the data file based on example embodiments described below. A second file, such as an information file, may also be used to record the status of the first file to ensure concurrent reading and writing to the data file by the plurality of widgets will not cause any inconsistencies.

One example method may include receiving a message from a first widget of a plurality of widgets for storage in a data file. The method may also include concurrently enabling another message in the data file to be accessed by at least a second widget of the plurality of widgets. The method may further include causing an information file to record a status of the data file to enable concurrent receiving and accessing of messages in the data file.

An example apparatus may include at least one processor and at least one memory storing computer program code, wherein the at least one memory and stored computer program code are configured, with the at least one processor, to cause the apparatus to at least receive a message from a first widget of a plurality of widgets for storage in a data file. The at least one memory and stored computer program code are further configured, with the at least one processor, to cause the apparatus to concurrently enable another message in the data file to be accessed by at least a second widget of the plurality of widgets. The at least one memory and stored computer program code are further configured, with the at least one processor, to cause the apparatus to cause an information file to record a status of the data file to enable concurrent receiving and accessing of messages in the data file.

In a further embodiment, a computer program product is provided that includes at least one non-transitory computer-readable storage medium having computer-readable program instructions stored therein, the computer-readable program instructions includes program instructions configured to receive a message from a first widget of a plurality of widgets for storage in a data file. The computer-readable program instructions also include program instructions configured to program instructions configured to concurrently enable another message in the data file to be accessed by at least a second widget of the plurality of widgets. The computer-readable program instructions also include program instructions configured to cause an information file to record a status of the data file to enable concurrent receiving and accessing of messages in the data file.

One example apparatus may include means for receiving a message from a first widget of a plurality of widgets for storage in a data file. The apparatus may also include means for concurrently enabling another message in the data file to be accessed by at least a second widget of the plurality of widgets. The apparatus may further include means for causing an information file to record a status of the data file to enable concurrent receiving and accessing of messages in the data file.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a schematic representation of an example inter-widget communications system having a data file in accordance with one embodiment of the present invention;

FIG. 2 is a block diagram of an example apparatus that may be embodied by a mobile terminal in accordance with one embodiment of the present invention;

FIG. 3 is an example block diagram of widget events during inter-widget communications performed in accordance with one embodiment of the present invention;

FIG. 4 is an example block diagram of an example format for a data file, information file and a message in accordance with one embodiment of the present invention;

FIG. 5 is a block diagram that shows an example inter-widget communications confirmation in accordance with an embodiment of the present invention;

FIGS. 6-10 show example block diagrams showing example data files and information files during inter-widget communications in accordance with an embodiment of the present invention; and

FIG. 11 illustrates an example flowchart illustrating inter-widget communications in accordance with an embodiment of the present invention.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or application specific integrated circuit for a mobile phone or a similar integrated circuit in a server, a cellular network device, or other network device.

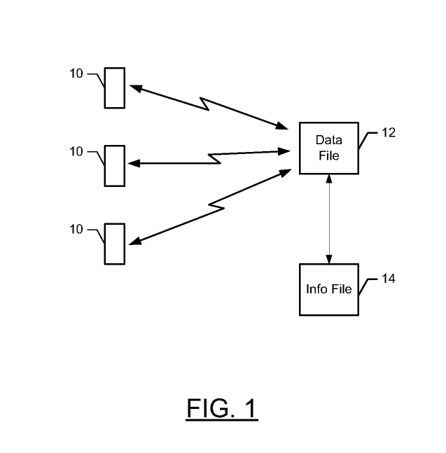

FIG. 1 is a schematic representation of an example inter-widget communications system in accordance with an embodiment of the present invention. In an embodiment, inter widget communications are accomplished, for example, by using file input and output operations. In particular one or more files may be used to allow for widgets 10 to read from and/or write to a file so as to allow data to be shared between the widgets 10. As is described herein, the read and/or write operations may be accomplished using messages that are stored in a data file 12. Such messages may be transferred to the data file 12 by one or more widgets 10 so that other widgets 10 may access one or more messages concurrently resulting in nearly instantaneous inter-widget communications.

In an embodiment, an information file 14 may then act as a backup as it is configured to record the status of the data file during read and/or write operations. Thus, multiple widgets 10 may concurrently interact with the data file 12 and in an instance in which the data file 12 becomes corrupted the information file 14 may be used to cure any inconsistencies in the data file 12.

In some example embodiments, the inter-widget communications system of FIG. 1 may be executed on a mobile terminal which may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the mobile terminal may include one or more processors that may define processing circuitry either alone or in combination with one or more memories. The processing circuitry may utilize instructions stored in the memory to cause the mobile terminal to operate in a particular way or execute specific functionality when the instructions are executed by the one or more processors. The mobile terminal may also include communication circuitry and corresponding hardware/software to enable communication with other devices and/or the network.

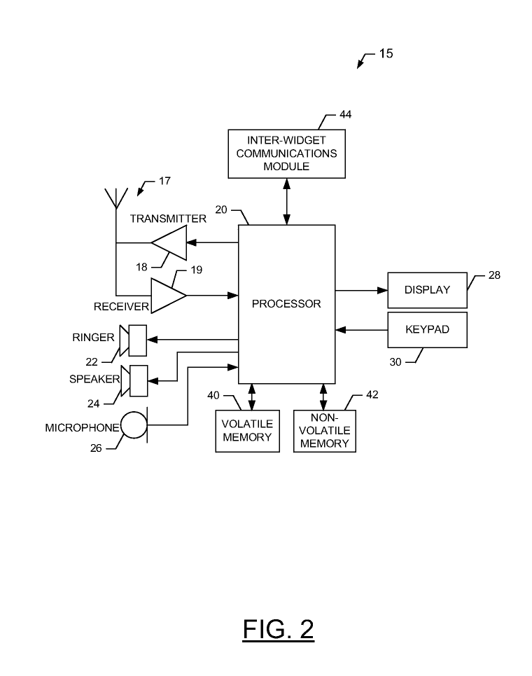

In one embodiment, for example, the mobile terminal may be embodied as or otherwise include an apparatus 15 as generically represented by the block diagram of FIG. 2. While the apparatus 15 may be employed, for example, by a mobile terminal it should be noted that the components, devices or elements described below may not be mandatory and thus some may be omitted in certain embodiments. Additionally, some embodiments may include further or different components, devices or elements beyond those shown and described herein.

In this regard, FIG. 2 illustrates an example block diagram of an apparatus 15. While several embodiments of a mobile terminal (e.g., apparatus 15) are illustrated and will be hereinafter described for purposes of example, other types of user terminals, such as mobile telephones, mobile computers, portable digital assistants (PDAs), pagers, laptop computers, desktop computers, gaming devices, televisions, and other types of electronic systems, may employ some embodiments of the present invention.

As shown, the apparatus 15 may include an antenna 17 (or multiple antennas 17) in communication with a transmitter 18 and a receiver 19. The apparatus 15 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the apparatus 15 may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from some embodiments of this invention, as should dual or higher mode phones (e.g., digital/analog or TDMA/CDMA/analog phones). Additionally, the apparatus 15 may be capable of operating according to Wireless Fidelity (Wi-Fi) or Worldwide

Interoperability for Microwave Access (WiMAX) protocols.

It is understood that the processor 20 may comprise circuitry for implementing audio/video and logic functions of the apparatus 15. For example, the processor 20 may comprise a digital signal processor device, a microprocessor device, an analog-to-digital converter, a digital-to-analog converter, and/or the like. Control and signal processing functions of the apparatus 15 may be allocated between these devices according to their respective capabilities. Further, the processor may comprise functionality to operate one or more software programs, which may be stored in memory. For example, the processor 20 may be capable of operating a connectivity program, such as a web browser. The connectivity program may allow the apparatus 15 to transmit and receive web content, such as location-based content, according to a protocol, such as Wireless Application Protocol (WAP), hypertext transfer protocol (HTTP), and/or the like. The apparatus 15 may be capable of using a Transmission Control Protocol/Internet Protocol (TCP/IP) to transmit and receive web content across the internet or other networks.

The apparatus 15 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In some embodiments including a keypad, the keypad may comprise numeric (0-9) and related keys (#, *), and/or other keys for operating the mobile terminal.

The apparatus 15 may comprise memory, such as a smart cart, subscriber identity module or subscriber identification module (SIM), a removable user identity module (R-UIM), and/or the like, which may store information elements related to a mobile subscriber. In addition to the SIM, the mobile terminal may comprise other removable and/or fixed memory. The apparatus 15 may include other non-transitory memory, such as at least one of a volatile memory 40 and/or at least one of a non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the apparatus 15.

A inter-widget communications module 44 may be embodied as various means, such as circuitry, hardware, a computer program product comprising computer readable program instructions stored on a computer readable medium (e.g., the memory 40) and executed by a processing device (e.g., the processor 20), or some combination thereof and, in one embodiment, is embodied as or otherwise controlled by the processor 20. In an embodiment, wherein the inter-widget communications module 44 is embodied separately from the processor 20, the inter-widget communications module 44 may be in communication with the processor 20. The inter-widget communications module 44 may further be in communication with one or more of the memory 40 and/or 42, the transmitter 18, and the receiver 19, such as via a bus.

The inter-widget communications module 44 may be configured to enable inter-widget communication by providing a connection between the widgets, such as widgets 10 in FIG. 1, and at least one data file, such as data file 12. The inter-widget communications module 44 may also provide a connection between a data file that is stored in the memory such as memory 40 and/or 42 and/or may provide a link to a remote data file reachable over the Internet such as by using means such as the transmitter 18 and/or the receiver 19 to interact with a remote data file.

In an embodiment, the inter-widget communications module 44 may be configured to enable at least one widget to send a message (e.g. a writing operation) and/or to access a message (e.g. reading operation). The inter-widget communications module 44 may receive a request for a widget to access a data file.

In order to access a data file, the widget may be assigned a position indicator. The position indicator may then identify the next message to be read in the data file and/or may identify the last message that was read by the widget. In instances in which a widget does not yet have a position indicator, the inter-widget communications module 44 may be configured to provide a position indicator for the widget. For example a position indicator may initially identify the oldest message in the data file, and then may subsequently be moved from one message to the next chronologically. Alternatively or additionally, a head field from the information file may be used to position the position indicator at the oldest message in the data file.

In an embodiment, once a position indicator has been assigned to a widget, the inter-widget communications module may then be configured to determine whether there is a message for that widget in the data file by looping through all of the messages in the data file. For example, there may be messages for any one of a plurality of widgets and some messages may not apply to all of the widgets. The inter widget communications module 44, is further configured to look at each message in the data file to determine a widget target. In an instance in which a message identifies the widget as the target or at least one of the targets, then the payload of the message may be retrieved and used by the widget during widget operations.

The inter-widget communications module 44 may also be configured to cause the data file to receive a message from a widget. In some embodiments, the inter-widget communications module 44 may cause the data file to be locked from receiving messages from other widgets until it concludes its current receiving operations. In other embodiments, a message may be stored in the queue for later transfer to the data file, the information file and/or the like. A binary exponential back off algorithm may also be used to avoid conflicts. Alternatively or additionally, the inter-widget communications module 44 may also indicate that the data file is locked by using a flag, which may be located in the start of the information file. Such a flag may be similar to mutex exclusion semaphore and/or the like.

In an embodiment, and once a widget has a lock on the data file, the inter-widget communications module 44 may then cause a message generated by the widget to be written to an available area in the data file. In particular, a message may be formatted for storage in the data file. For example, the inter-widget communications module 44 may determine an available area border for the message and then may try to allocate the size of a length field of the message from the current available area. An allocating algorithm may be used such as a first fit, a best fit, a worse fit, or the like which may be similar to memory allocation system of the apparatus 20.

In an instance in which the allocation is successful, the inter-widget communications module 44 may be configured to write the message to the data file and may also provide any updates to the fields of the data file. The inter-widget communications module 44 may then release the lock and allow other widgets to write to the data file. In an embodiment and in an instance in which the message could not be allocated, then the inter-widget communications module 44 may clean up the data file by deleting old messages to make the requisite space available and/or may reallocate the message.

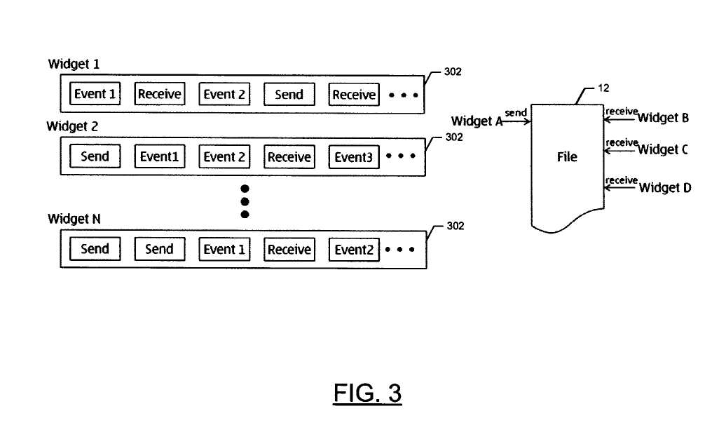

FIG. 3 is an example block diagram of widget events during inter-widget communications performed in accordance with one embodiment of the present invention. In an embodiment, widgets are generally written in a script language, such as JavaScript. Thus, to execute a widget, a script parser is normally implemented by a main thread which is equipped with an event queue 302. The events in the event queue 302 may include user interactions (e.g. mouse clicks), a timer, system notifications, etc. Alternatively or additionally, sending or receiving data, such as the file input and output operations with a data field may also be considered to be events to be tracked by the widget in the event queue 302. Each widget may track its own events and thus may have separate events in their event queue 302. As is shown with respect to the data file 12, the events in the event queue may result in concurrent access to the data file 12.

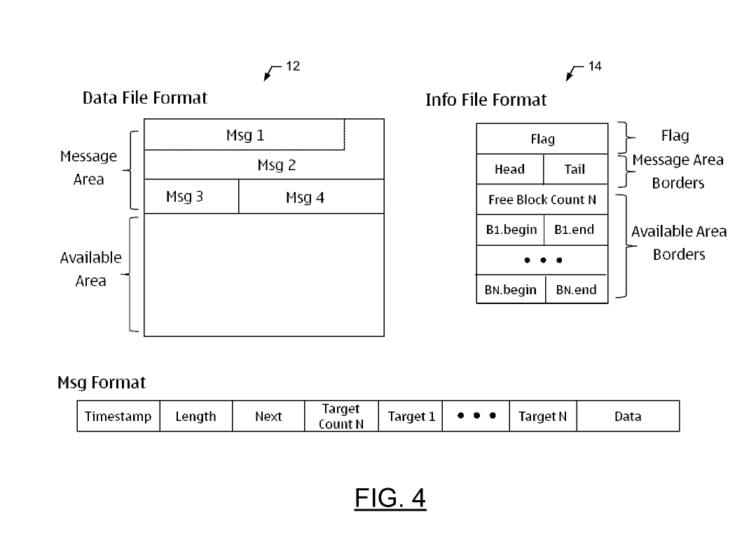

FIG. 4 is an example block diagram of an example format for a data file, information file and a message in accordance with one embodiment of the present invention. In an embodiment, the data file 12 may be divided into multiple parts, such as a message area and an available area. The message area may contain a chain of messages sent by a widget. These messages may be formatted with a timestamp that indicates when they were received. The timestamp may be used, for example by the inter-widget communications module 44 to clean up the data file in an instance in which the time in the data file exceeds a predetermined time. The messages may also include a length field that represents the total length of a message along with a next field that indicates a starting position of a next message in the data file. A target count field may also be used to describe the number of widgets that may be receiving the message. A following target count file may be used to identify a list of widgets that are to receive a particular message. A payload field may also be included that contains the payload of the message.

The data file 12 also may include available area that is separate from the message space. The available area is comprised of a number of discrete blocks and a block table is used to delineate the available space.

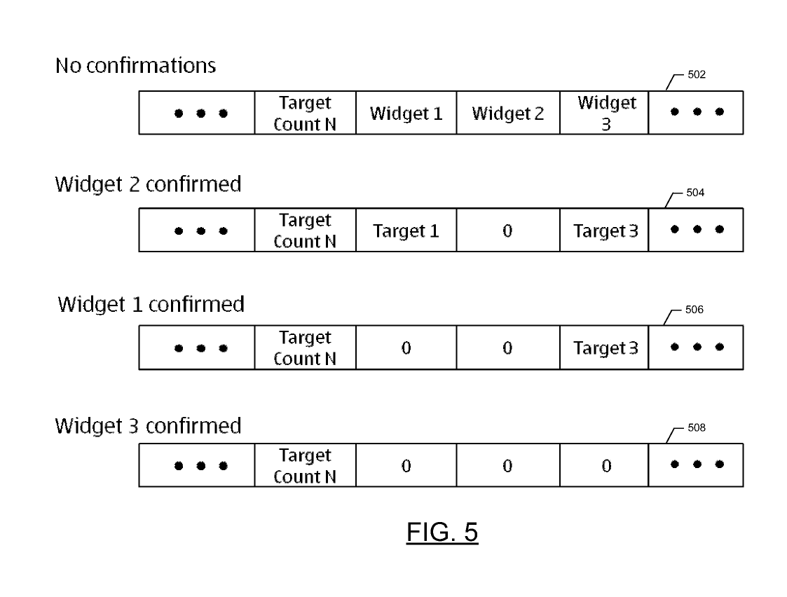

FIG. 5 is a block diagram that shows an example inter-widget communications confirmation in accordance with an embodiment of the present invention.

As is shown in area 502, a message may not have been confirmed by any widgets and therefore the target list includes the target widgets by name. At area 504, widget 2 may confirm the message and thus the message may remove widget 2 from the list. At area 506, widget 1 confirms and similarly widget 1 is removed from the list. At area 508, widget 3 may confirm the message and thus all widgets have confirmed receiving the message. Once a message has been confirmed by all targets, it may be cleared from the data file.

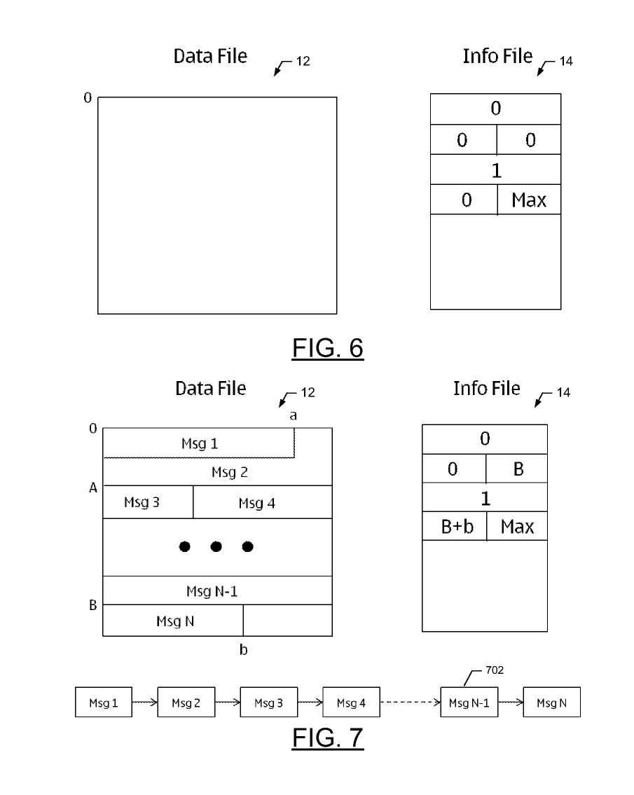

FIGS. 6-10 show example block diagrams showing example data files and information files during inter-widget communications in accordance with an embodiment of the present invention. FIG. 6 illustrates a data file that is empty and therefore has not received messages from any of the widgets or has been cleared of the data. Accordingly, the head and the tail field of the information file are set to zero and the free block is set from zero to max indicating that the data file is empty.

FIG. 7 illustrates a data file and an information file containing messages. The message area includes messages from Msg1 to MsgN and the messages may be generally connected with a next field as is shown with reference message chain 702. For example, MsgN may start from position B and may have a length of b, the Tail field of the information file may then be modified to B and the begin position field of free block may then be set to B+b.

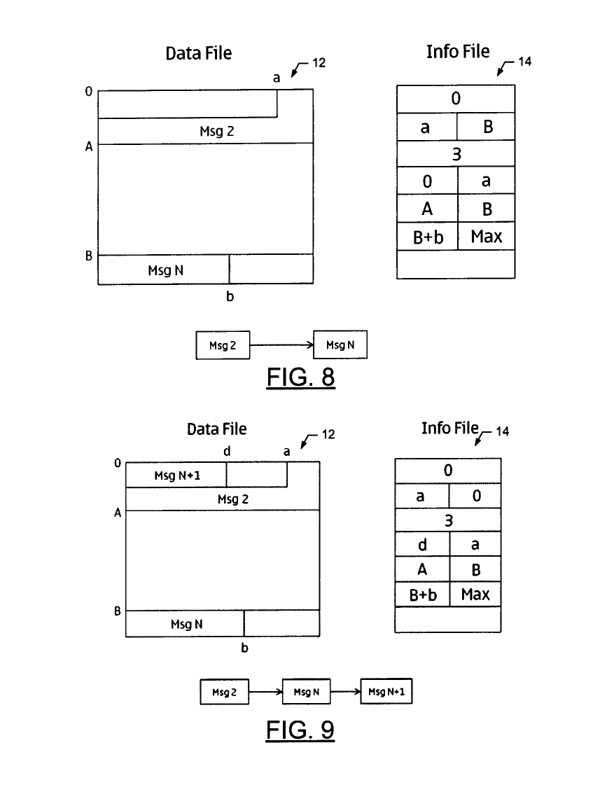

In an embodiment and by way of example, a widget may send a message such as MsgN+1 after obtaining the lock as is described with reference to the inter-widget communications module 44 of FIG. 2. However, in this example there may not be an area of sufficient size and thus cleaning up the data file takes place. In this example, it may be found by checking Msg1 to MsgN, that Msg2 and MsgN are not confirmed by all the targets, so they cannot be deleted from the message area. Thus, the message area shrinks and a new chain containing only Msg2 and MsgN is created, as shown in FIG. 8. After merging the deleted messages, the available area may be composed of three free blocks due to the interruption of Msg2 and MsgN. The borders of these three blocks may be (0, a), (A, B), (B+b, Max). Accordingly, the Head and Tail field of the information file may be updated to a and B as Msg2 starts from position a.

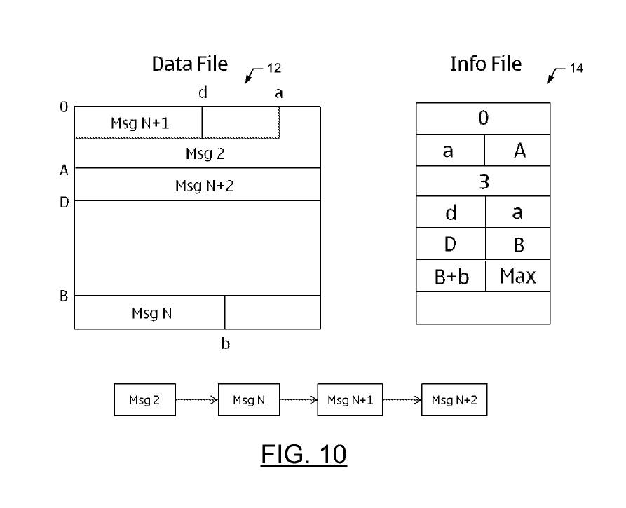

FIG. 8 illustrates the content of the data file and the information file after cleaning up the data file as shown in FIG. 7. Thus, the size of Msg N+1 may now fit in the available area. In an embodiment and by using first-fit allocation algorithm, MsgN+1 may be allocated in the space from position 0 and its length is d. In such a case, the Tail field and the begin position of first free block in the information file may be set to 0 and d respectively, as is illustrated in FIG. 9. FIG. 10 illustrates the content of data file and info file after another widget sends a message, such as message MsgN+2. Similar to the procedure described with respect to FIGS. 7 and 8, the Tail field and the begin position of a last free block in info file may then be set to A and D.

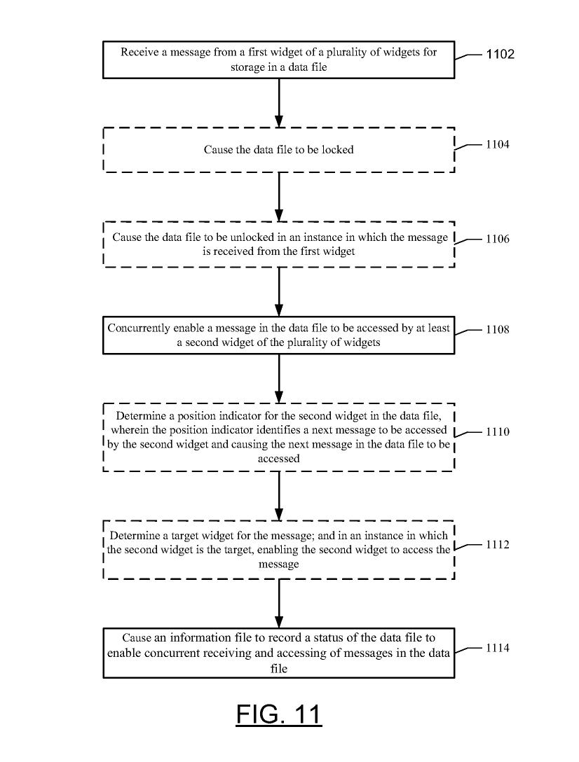

FIG. 11 illustrates an example flowchart of the example operations performed by a method, apparatus and computer program product in accordance with one embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 40, 42 of an apparatus employing an embodiment of the present invention and executed by a processor 20 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIG. 11, when executed, convert a computer or processing circuitry into a particular machine configured to perform an example embodiment of the present invention. Accordingly, the operations of FIG. 11 define an algorithm for configuring a computer or processing to perform an example embodiment. In some cases, a general purpose computer may be provided with an instance of the processor which performs the algorithms of FIG. 11 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations above either alone or in combination with any others among the features described herein.

FIG. 11 is an example flowchart illustrating inter-widget communications performed in accordance with an embodiment of the present invention. As shown in operation 1102, the apparatus 15 may include means, such as the transmitter 18, the receiver 19, the processor 20, the inter-widget communications module 44, or the like, for receiving a message from a first widget of a plurality of widgets for storage in a data file. A message may also be received from any one of a plurality of widgets. However, in an instance in which a message is to be received and as shown in operation 1104, the apparatus 15 may include means, such as the processor 20, the inter-widget communications module 44, or the like, for causing the data file to be locked. Thus only allowing a single message to be written to the data file. Then, as is shown in operation 1106, the apparatus 15 may include means, such as the processor 20, the inter-widget communications module 44, or the like, for causing the data file to be unlocked in an instance in which the message is received from the first widget. Thus once the writing operation is completed, the data file may be unlocked so as to allow another widget to write to the data file.

As is shown in operation 1108, the apparatus 15 may include means, such as the processor 20, the inter-widget communications module 44, or the like, for concurrently enabling a message in the data file to be accessed by at least a second widget of the plurality of widgets. In order for the message to be accessed, as is shown in operation 1110, the apparatus 15 may include means, such as the processor 20, the inter-widget communications module 44, or the like, for determining a position indicator for the second widget in the data file, wherein the position indicator identifies a next message to be accessed and causing the message in the data file to be accessed based on the determined position indicator. As is shown in operation 1112, the apparatus 15 may include means, such as the processor 20, the inter-widget communications module 44, or the like, for determining a target for the message; and in an instance in which the second widget is the target, enabling the widget to access the message. As is shown in operation 1114, the apparatus 15 may include means, such as the processor 20, the inter-widget communications module 44, or the like, for causing an information file to record a status of the data file to enable concurrent receiving and transmitting of messages to and from the data file.

Advantageously, the inter-widget communications systems as described herein may, for example, allow for the combination of widgets and to allow for widgets to communicate in such a way that allows for an improved user experience. Additionally, for example, the inter-widget communications system may enable cross engine communications(across runtime environments). Alternatively or additionally, some embodiments described herein may also allow for increased efficiency, may not require server support, may support unicast, multicast and broadcast and may ultimately be more reliable. Although widget is used throughout the description, the systems and methods described herein may also be functional for mobile applications (apps), desktop applications and/or other executable files that are capable of read/write operations.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-28. (canceled)

29. A method comprising:
receiving a message from a first widget of a plurality of widgets for storage in a data file;
concurrently enabling another message in the data file to be accessed by at least a second widget of the plurality of widgets; and
causing an information file to record a status of the data file to enable concurrent receiving and accessing of messages in the data file.

30. A method of claim 29 wherein concurrently enabling the message in the data file to be accessed by the second widget of the plurality of widgets further comprises determining a position indicator for the second widget in the data file, wherein the position indicator identifies a next message to be accessed by the second widget and causing the next message in the data file to be accessed.

31. A method of claim 30 wherein causing the message in the data file to be accessed based on the determined position indicator further comprises determining a target widget for the message; and in an instance in which the second widget is the target, enabling the second widget to access the message.

32. A method of claim 30 wherein causing the next message in the data file to be accessed further comprises causing the position indicator to increment to a next message in the data file and enabling the second widget to access the next message.

33. A method of claim 29 further comprises in an instance in which a widget does not have a position indicator in the data file, causing a position indicator to be created in the data file and assigning the position indicator to an oldest message in the data file.

34. A method of claim 29 wherein the data file is configured to contain a plurality of messages.

35. A method of claim 29 wherein receiving the message from the first widget of a plurality of widgets for storage in a data file further comprises causing the data file to be locked; and in an instance in which the message is received from the first widget, causing the data file to be unlocked.

36. An apparatus comprising at least one processor and at least one memory storing computer program code, wherein the at least one memory and stored computer program code are configured, with the at least one processor, to cause the apparatus to at least:
receive a message from a first widget of a plurality of widgets for storage in a data file;
concurrently enable another message in the data file to be accessed by at least a second widget of the plurality of widgets; and
cause an information file to record a status of the data file to enable concurrent receiving and accessing of messages in the data file.

37. An apparatus of claim 36 wherein the at least one memory and stored computer program code are further configured, with the at least one processor, to cause the apparatus to determine a position indicator for the second widget in the data file, wherein the position indicator identifies a next message to be accessed by the second widget and cause the next message in the data file to be accessed.

38. An apparatus of claim 37 wherein the at least one memory and stored computer program code are further configured, with the at least one processor, to cause the apparatus to determine a target widget for the message; and in an instance in which the second widget is the target, enable the second widget to access the message.

39. An apparatus of claim 37 wherein the at least one memory and stored computer program code are further configured, with the at least one processor, to cause the apparatus to cause the position indicator to increment to a next message in the data file and enable the second widget to access the next message.

40. An apparatus of claim 36 wherein the at least one memory and stored computer program code are further configured, with the at least one processor, to cause the apparatus to cause a position indicator to be created in the data file and assign the position indicator to an oldest message in the data file in an instance in which a widget does not have a position indicator in the data file.

41. An apparatus of claim 36 wherein the data file is configured to contain a plurality of messages.

42. An apparatus of claim 36 wherein the at least one memory and stored computer program code are further configured, with the at least one processor, to cause the apparatus to causing the data file to be locked; and in an instance in which the message is received from the first widget, cause the data file to be unlocked.

43. A computer program product comprising at least one non-transitory computer-readable storage medium having computer-readable program instructions stored therein, the computer-readable program instructions comprising:
program instructions configured to receive a message from a first widget of a plurality of widgets for storage in a data file;
program instructions configured to concurrently enable another message in the data file to be accessed by at least a second widget of the plurality of widgets; and
program instructions configured to cause an information file to record a status of the data file to enable concurrent receiving and accessing of messages in the data file.

44. A computer program product of claim 43 wherein the computer-readable program instructions further comprise program instructions configured to determine a position indicator for the second widget in the data file, wherein the position indicator identifies a next message to be accessed by the second widget and program instructions configured to cause the next message in the data file to be accessed.

45. A computer program product of claim 44 wherein the computer-readable program instructions further comprise program instructions configured to determine a target widget for the message; and in an instance in which the second widget is the target, program instructions configured to enable the second widget to access the message.

46. A computer program product of claim 44 wherein the computer-readable program instructions further comprise program instructions configured to cause the apparatus to cause the position indicator to increment to a next message in the data file and program instructions configured to enable the second widget to access the next message.

47. A computer program product of claim 43 wherein the computer-readable program instructions further comprise program instructions configured to cause a position indicator to be created in the data file and program instructions configured to assign the position indicator to an oldest message in the data file in an instance in which a widget does not have a position indicator in the data file.

48. A computer program product of claim 43 wherein the data file is configured to contain a plurality of messages.
